(19) United States
(12) Patent Application Publication
(10) Pub. No.: US 2007/0250815 A1
(43) Pub. Date: Oct. 25, 2007

(54) MEASURING CODE COVERAGE

(75) Inventors: Perraju Bendapudi, Hyderabad (IN); Siddharth Rana, Hyderabad (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/379,632

(22) Filed: Apr. 21, 2006

(51) Int. Cl. G06F 9/44

(52) U.S. Cl. 717/124; 717/151

(57) ABSTRACT

A facility for measuring code coverage of an executable object is described. The facility requests an identification of basic blocks of the executable object, adds a data structure to the executable object for storing code coverage information, and adds to each basic block of the executable object program instructions for updating an element of the data structure corresponding to the basic block. When the executable object performs, each basic block that is performed updates an element of the added data structure corresponding to the basic block. When the executable object terminates, it updates a file comprising an indication of basic blocks that have been performed.

### TECHNICAL FIELD

The described technology relates generally to testing software.

### BACKGROUND

Source code is a series of instructions that command a computing system to perform operations that together define a software application. Complex software applications can have millions of instructions in their source code. When developing software applications (“software” or “programs”), software developers generally provide source code using a human-readable computer programming language, such as C, C++, MICROSOFT VISUAL C#, or MICROSOFT VISUAL BASIC. A software application's source code is a collection of files comprising source code that can be converted from human-readable form to a corresponding computer-executable form by using tools such as compilers or interpreters. Compilers and interpreters are tools that convert source code to object code or execution code. Linkers are tools that convert object code to execution code. Object code and execution code may simply be referred to as object code herein.

When software developers develop software applications, they sometimes inadvertently introduce programming errors in source code. Compilers and interpreters are able to detect many of these errors. For example, C++ compilers may be able to identify missing parameters in function calls. However, these tools are unable to detect all errors in software applications.

As a result, software testers “dynamically” test software applications before the software applications are provided to users. Dynamic testing occurs when the software application that is being tested is executed during the testing. In complex software applications with millions of lines of code, however, software testers may be unable to test all aspects of the software in a reasonable amount of time because of the large number of software instructions and complex logic with many paths of execution. As a result, software developers may provide software applications to users containing errors that were undetected by the tools and software testers.

Some of these errors could cause critical failures or resource leaks when users employ such software applications. Providing software, such as operating systems, with errors can be particularly problematic because many other software applications may depend on the software to perform adequately without errors. As an example, software applications may depend on operating system components, such as subsystems, to perform without errors. Software testers may thus need to ensure that all software instructions are adequately tested. To do this, software testers typically create test cases. These test cases attempt to cover all software code under different scenarios. However, in complex software applications, testers may be uncertain whether their test cases cover all the software application's code because they may be unaware of which program instructions were actually tested.

It would thus be highly desirable to provide a tool for measuring the code coverage of testing efforts.

### BRIEF DESCRIPTION OF THE DRAWINGS

FIG. 1 is a block diagram illustrating an example of a suitable computing environment in which the techniques may be implemented.

FIG. 2 is a block diagram illustrating an example of an operating system of the computing environment of FIG. 1.

FIG. 3 is a block diagram illustrating tools used during software programming.

FIG. 4 is a block diagram illustrating various tools of the facility and their relationship to other aspects of the facility in an embodiment.

FIG. 5 is a block diagram illustrating an executable object adapted by the facility in an embodiment.

FIG. 6 is a data structure diagram illustrating a data structure configured to store coverage data in an embodiment.

FIG. 7 is a flow diagram illustrating an initialize routine in an embodiment.

FIG. 8 is a flow diagram illustrating an example of a basic block routine in an embodiment.

FIG. 9 is a flow diagram illustrating an update_coverage_file routine in an embodiment.

FIG. 10 is a flow diagram illustrating a report_code_coverage routine in an embodiment.

### DETAILED DESCRIPTION

A facility is provided for measuring the code coverage of testing efforts. In various embodiments, the facility employs a tool that analyzes and manipulates object code of a software application (“object code tool”) to identify basic blocks in the object code and to instrument the object code for code coverage measurement. The object code tool provides an application program interface (“API”) that may be used by other computer programs, such as test tools, to request the object code tool to build call graphs, analyze variables, instrument object code, and perform other functions associated with object code. A call graph is a representation of control flow of object code. The call graph may indicate associations between “basic blocks” of object code. Basic blocks are typically code fragments not having any jumps.

In various embodiments, the test tool employs the object code tool to identify basic blocks in the executable object. Once the basic blocks are identified, the test tool instruments the object code of the software application by adding a data structure to the object code to store code coverage information and to add code to the object code to update this data structure. As an example, the test tool may add an array comprising at least as many elements as there are basic blocks in the object code. In various embodiments, a software developer may add the data structure to the object code. The test tool adds some program instructions near or within each basic block to update the data structure, such as to increment or set an element of the data structure corresponding to the basic block. As an example, the program instructions may set an element to a value indicating that its corresponding basic block has been executed. When the object code is subsequently executed in a test case, each basic block that is executed updates its corresponding element of the data structure to indicate that its code has been covered by the test case. Because the program instructions to update the data structure are added to each basic block without affecting the existing program instructions of the basic block, the software application defined by the basic blocks continues to function as expected.

In various embodiments, when the instrumented software application terminates, code added to the object code updates a file containing code coverage information comprising information from the data structures (“coverage file”). The updated coverage file comprises indications of basic blocks whose code has been executed, and thus covered by the test cases.

In various embodiments, a test tool may report code coverage. This test tool retrieves the coverage file created by the instrumented software application and provides an indication to a software tester of basic blocks that have not been executed during the test cases.

Thus, by utilizing the facility, a software tester is able to quickly determine which portions of a software application have not received sufficient code coverage during testing. The facility may be employed to test any object code, including an operating system's subsystem.

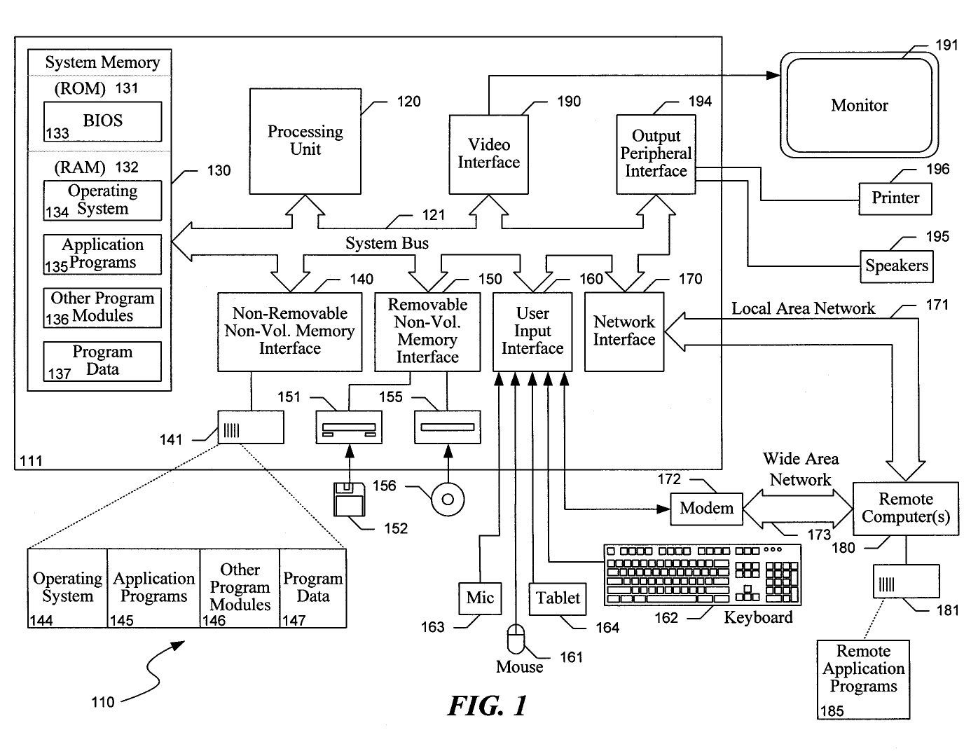

Turning now to the figures, FIG. 1 is a block diagram illustrating an example of a suitable computing system environment 110 or operating environment in which the techniques or facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary operating environment 110.

The facility is operational with numerous other general purpose or special purpose computing system environments or configurations. Examples of well-known computing systems, environments, and/or configurations that may be suitable for use with the facility include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the facility includes a general purpose computing device in the form of a computer 111. Components of the computer 111 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 111 typically includes a variety of computer-readable media. Computer-readable media can be any available media that can be accessed by the computer 111 and includes both volatile and nonvolatile media and removable and nonremovable media. By way of example, and not limitation, computer-readable media may comprise computer storage media and communication media. Computer storage media include volatile and nonvolatile, removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 111. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as a wired network or direct-wired connection, and wireless media, such as acoustic, RF, infrared, and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within the computer 111, such as during start-up, is typically stored in ROM 131. RAM 132 typically contains data and/or program modules that are immediately accessible to and/or presently being operated on by the processing unit 120. By way of example, and not limitation, FIG. 1 illustrates an operating system 134, application programs 135, other program modules 136, and program data 137.

The computer 111 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a nonremovable memory interface, such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 111. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 111 through input devices such as a tablet or electronic digitizer 164, a microphone 163, a keyboard 162, and a pointing device 161, commonly referred to as a mouse, trackball, or touch pad. Other input devices not shown in FIG. 1 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch screen panel can be physically coupled to a housing in which the computer 111 is incorporated, such as in a tablet-type personal computer. In addition, computing devices such as the computer 111 may also include other peripheral output devices such as speakers 195 and a printer 196, which may be connected through an output peripheral interface 194 or the like.

The computer 111 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 111, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprisewide computer networks, intranets, and the Internet. For example, in the present facility, the computer 111 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 111 is connected to the LAN 171 through a network interface or adapter 170. When used in a WAN networking environment, the computer 111 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 111, or portions thereof, may be stored in the remote memory storage device 181. By way of example, and not limitation, FIG. 1 illustrates remote application programs 185 as residing on memory storage device 181. It will be appreciated that the network connections shown are exemplary and other means of establishing a communications link between the computers may be used.

While various functionalities and data are shown in FIG. 1 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

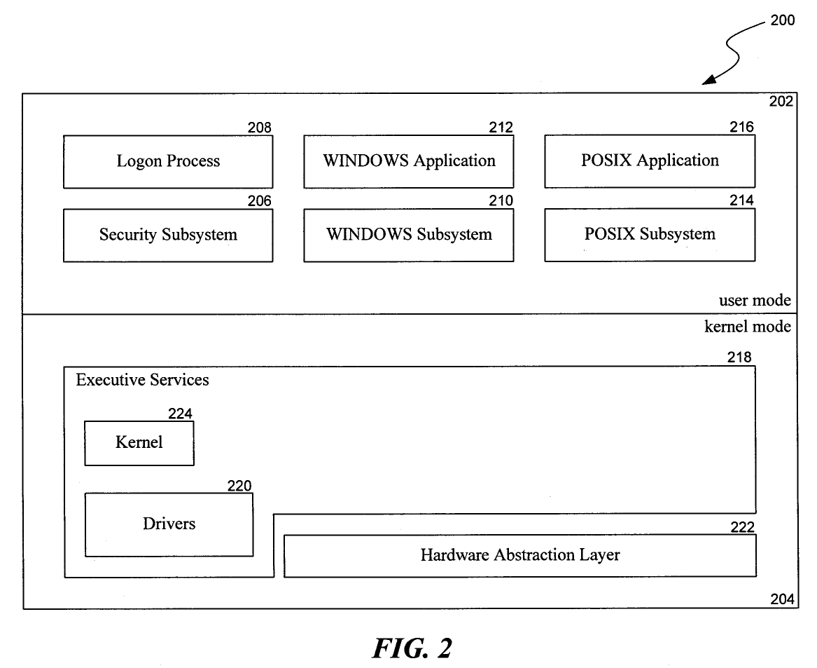

FIG. 2 is a block diagram illustrating an example of an operating system of the computing environment of FIG. 1. The operating system 200 comprises multiple components operating in a user mode 202 and a kernel mode 204.

Components operating in the user mode include, e.g., a security subsystem 206, logon process 208, WINDOWS subsystem 210, WINDOWS application 212, POSIX subsystem 214, and POSIX application 216.

The security subsystem provides security services to applications and the operating system. As an example, the security subsystem may provide the logon process 208 and functionality to enable users to log on to the operating system.

The WINDOWS subsystem may provide MICROSOFT WINDOWS functionality to applications, such as WINDOWS applications. The WINDOWS subsystem may implement an application program interface relating to the MICROSOFT WINDOWS operating system. As an example, the WINDOWS subsystem may receive a request made by a WINDOWS application to an API of the WINDOWS subsystem, perform some activities relating to the request, and call an operating system kernel to perform remaining activities.

The operating system may also have additional subsystems, such as a POSIX subsystem 214. The POSIX subsystem may implement an API relating to an operating system that complies with a POSIX specification. The API may be used by a POSIX application 216 to communicate with the POSIX operating system to perform tasks.

When an operating system comprises multiple subsystems, it is capable of providing multiple varieties of operating systems, such as MICROSOFT WINDOWS and POSIX. Thus, applications designed for these varieties of operating systems may function on the operating system comprising multiple subsystems.

The subsystems may utilize services provided by an executive services component 218 operating in kernel mode 204. The executive services component may comprise additional components, such as drivers 220 and a kernel 224. The drivers may provide direct communications between various software and hardware components of the system. As an example, a driver may provide communications between software components and a network interface card. The kernel may provide core operating system functions and communications with a processor. As an example, the kernel may schedule thread execution by loading program registers and instructing the processor to begin executing a thread. A hardware abstraction layer 222 may also operate in kernel mode to provide operating system components and interfaces relating to hardware devices. The hardware abstraction layer may enable software components of the operating system to avoid having to provide functionality specific to a particular vendor's hardware device.

The facility may be used to test various components of the operating system or applications. As an example, the facility may be used to test the POSIX subsystem.

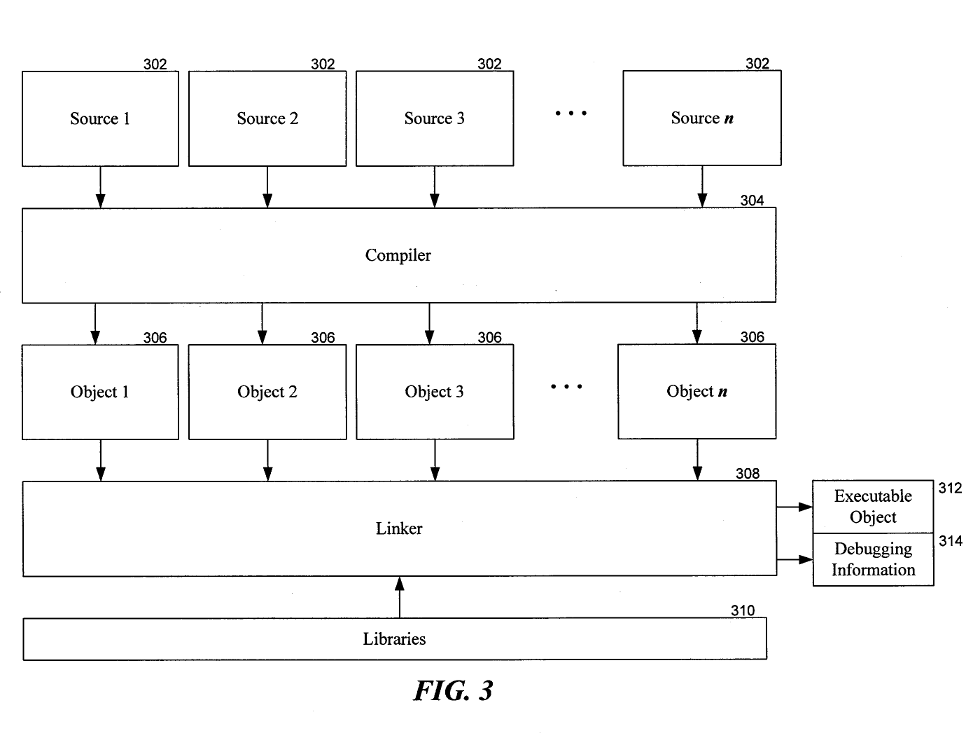

FIG. 3 is a block diagram illustrating tools used during software programming. A software application may have multiple source code files 302. The source code files may be provided by a software developer using a human-readable language, such as C or C++. The source code files may be provided in multiple different languages. As an example, a software application may have source code files provided in C, C++, VISUAL BASIC, and other languages.

One or more compilers 304 may compile the source code into corresponding object code files 306. As an example, a C compiler may compile a source code file having instructions provided in the C language into an object code file. Similarly, a C++ compiler may compile a source code having instructions provided in the C++ language into an object code file.

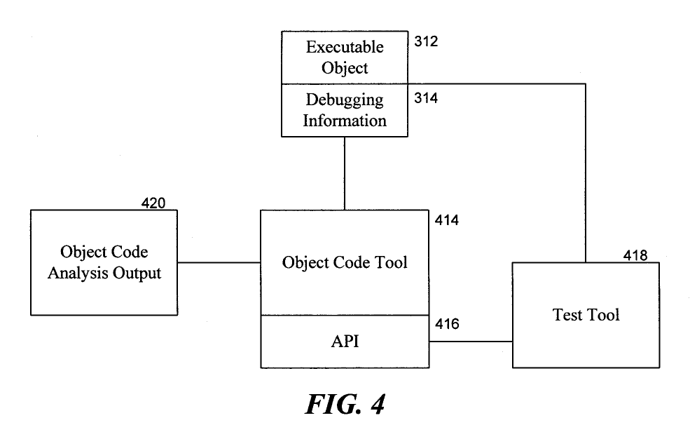

A linker 308 may generate an executable object file (“executable object”) 312 based on the object code files 306. The linker may further use runtime libraries 310 when generating the executable object file. One or more executable object files may provide the functionality of a software application. The linker or compiler may also produce debugging information 314 associated with the executable object. The debugging information may provide an association between executable code embedded in the executable object and the source code. This debugging information may be used during debugging, e.g., by a debugging tool. The debugging information may also be used by the object code tool, as further described immediately below in relation to FIG. 4.

FIG. 4 is a block diagram illustrating various tools of the facility and their relationship to other aspects of the facility in an embodiment. The executable object 312 and the debugging information 314 may be provided to an object code tool 414.

The object code tool may utilize the debugging information and the executable object to generate an object code analysis output 420, such as a call graph. The object code tool may receive requests to provide the object code analysis output from another software application, such as test tool 418. This software application may utilize the object code tool's API, such as API 416.

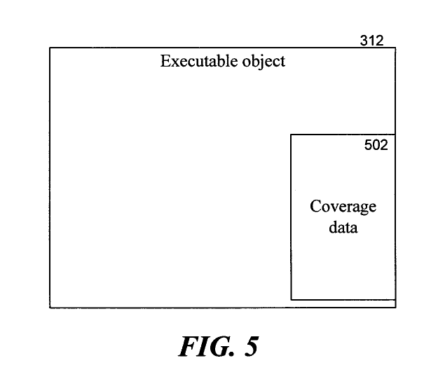

FIG. 5 is a block diagram illustrating an executable object adapted by the facility in an embodiment. The executable object 312 includes a data structure 502 for storing coverage data. The data structure may be an array comprising at least as many elements as there are basic blocks in the executable object. The test tool 418 may have requested the object code tool to add the data structure to the executable object during instrumentation of the executable object. The facility stores code coverage information in the added data structure.

In various embodiments, the data structure may be stored outside the executable object, and the executable object may be adapted with program instructions for accessing the data structure.

In various embodiments, other data structures may be used to store code coverage information.

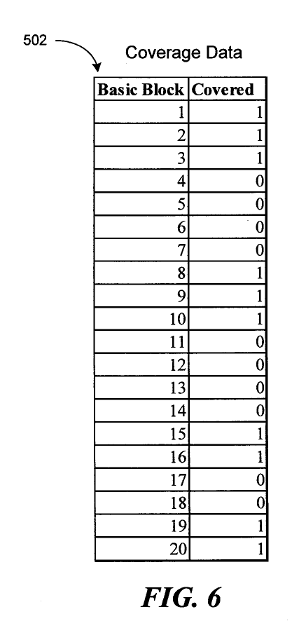

FIG. 6 is a data structure diagram illustrating a data structure configured to store coverage data in an embodiment. The data structure 502 may be an array, as described above in relation to FIG. 5 and as illustrated in FIG. 6. The array may comprise at least two columns and as many rows as there are basic blocks in the executable object. The columns include an indication of a basic block and a corresponding indication of whether the basic block's code has been covered, such as by being performed during a test case. The indication of whether the basic block's code has been covered may simply be a nonzero positive integer, TRUE/FALSE, or other data types. In various embodiments, the indication of whether the basic block's code has been covered may be a bit that is “on.” In contrast, an “off” bit may be an indication that the basic block's code has not yet been performed.

While FIG. 6 illustrates a table whose contents and organization are designed to make them more comprehensible by a human reader, those skilled in the art will appreciate that actual data structures used by the facility to store this information may differ from the table shown, in that they, for example, may be organized in a different manner, may contain more or less information than shown, may be compressed and/or encrypted, etc.

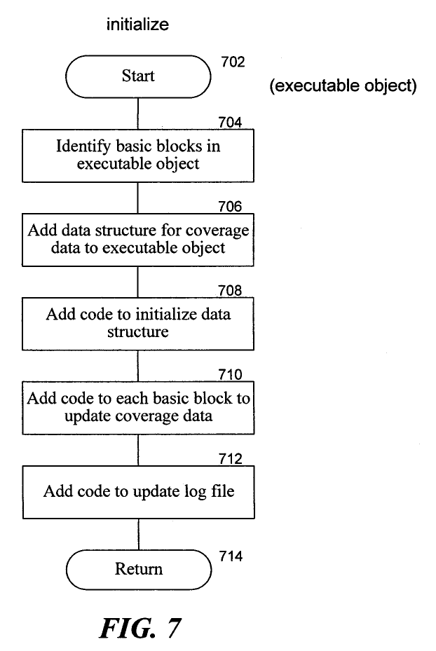

FIG. 7 is a flow diagram illustrating an initialize routine in an embodiment. The routine may be performed by the test tool to prepare an executable object for use by the facility. The routine begins at block 702 where it may receive an indication of an executable object as a parameter. Examples of executable objects include, but are not limited to, executable files, dynamic link libraries, or any executable software component, such as software applications or operating system components.

At block 704, the routine identifies basic blocks in the indicated executable object. The routine may request an object code tool to analyze the executable object to identify the basic blocks. In response to the request, the routine may receive an indication of the basic blocks from the object code tool.

At block 706, the routine may add a data structure for storing code coverage information to the executable object. As an example, the routine may add an array to the executable object, such as the array illustrated in FIG. 6. The data structure may be configured to comprise at least as many basic blocks as were identified at block 704.

At block 708, the routine may add to the executable object program instructions for initializing the data structure added at block 706. As an example, the added program instructions may set all elements of the array to zero or “off” to indicate that basic blocks corresponding to the array elements have not yet been performed. The routine may configure the executable object to perform these program instructions when the executable object starts. These program instructions may additionally create a coverage file when this file is not found.

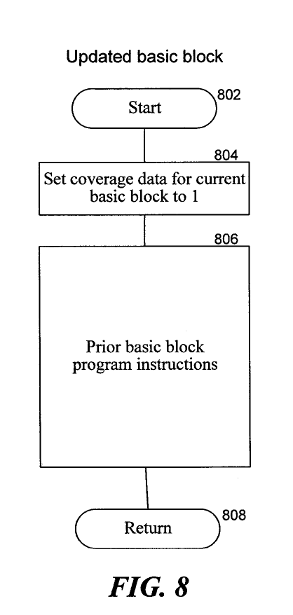

At block 710, the routine may add code to each basic block to update the data structure added at block 706. The routine may add to the basic blocks program instructions for updating the data structure, as described in further detail below in relation to FIG. 8. The routine may add this code before, within, or at the end of each basic block without affecting the existing logic of the basic block.

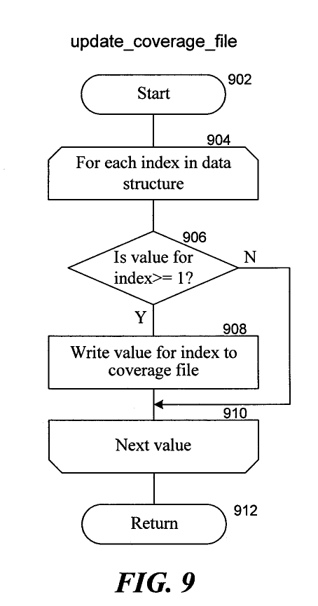

At block 712, the routine may add to the executable object program instructions for updating a coverage file in which the values stored in the added data structure will be written when the executable object terminates. These program instructions are further described below in relation to FIG. 9. The routine may configure the executable object to perform these program instructions when the executable object terminates.

At block 714, the routine returns.

FIG. 8 is a flow diagram illustrating an example of an updated basic block in an embodiment. The routine begins at block 802.

At block 804, the routine sets code coverage data in the data structure corresponding to the current basic block (e.g., the basic block performing the routine) to indicate that the current basic block has been performed. As an example, the routine may determine an array element to update based on an identification of the basic block. The array element may be updated by setting it to “on” or by setting or by incrementing its value. The routine may utilize an indication of the basic block's identification in determining which array element to update. This indication may have been added by the object code tool during instrumentation of the executable object. The test tool may add the program instructions of block 804 to each basic block by utilizing the object code tool's API.

At block 806, the routine continues performance of the program instructions of the current basic block that existed before the basic block was modified. Although the routine indicates that the setting of coverage data occurs prior to the performance of the basic blocks, coverage data can instead be set inside or at the end of the basic block in various embodiments.

At block 808, the routine returns.

Although multiple blocks are illustrated to describe the routine, only the code of block 804 may actually be added to each basic block.

FIG. 9 is a flow diagram illustrating an update_coverage_file routine in an embodiment. The routine may be performed by program instructions added to an executable object when the executable object terminates. The routine updates a coverage file to indicate which basic blocks have been performed. The routine begins at block 902.

Between blocks 904 and 910, the routine may write a value to the coverage file when the value of a selected element is nonzero. At block 904, the routine selects a value in the data structure added to the executable object during instrumentation.

At block 906, the routine determines whether the selected value is nonzero or “on.” If the selected value is nonzero or “on,” the routine continues at block 908. Otherwise, the routine continues at block 910.

At block 908, the routine writes the selected value to the coverage file.

At block 910, the routine selects the next value.

At block 912, the routine returns.

Thus, the coverage file may contain a data structure that is similar to the data structure that is updated by each basic block. However, the data structure of the coverage file may contain information updated after each invocation of the executable object. In various embodiments, it may be more suitable to update the coverage file in this manner than to simply dump the contents of the data structure so that the coverage file accurately depicts code coverage as a result of multiple test cases performing multiple invocations of the executable object. If the contents of the data structure were merely dumped to the coverage file and thereby overwrote existing data, a tester would find it more difficult to keep track of code coverage after multiple separate invocations of the executable object during test cases.

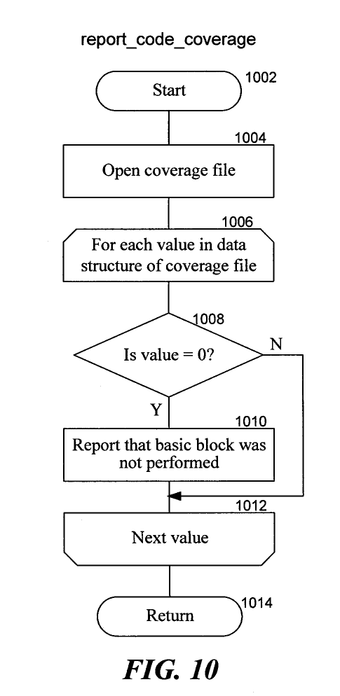

FIG. 10 is a flow diagram illustrating a report_code_coverage routine in an embodiment. The routine may be performed by a test tool. The routine begins at block 1002.

At block 1004, the routine opens the coverage file described above in relation to FIG. 9.

Between blocks 1006 and 1010, the routine determines whether a selected value corresponding to a basic block has been set to a value other than zero or “off,” thereby indicating that the basic block has been performed.

At block 1006, the routine selects a value in the coverage file.

At block 1008, the routine determines whether the value is zero or “off.” If the value is zero or “off,” the routine continues at block 1010. Otherwise, the routine continues at block 1012.

At block 1010, the routine reports that the basic block corresponding to the selected value was not performed. The routine may also provide an indication of line numbers in source code or object code of the executable object corresponding to the basic block. The routine may be able to determine the line numbers by associating an identification of the basic block with the executable object's debugging information. In various embodiments, the routine may make this determination by utilizing the object code tool's API.

At block 1012, the routine selects another value.

At block 1014, the routine returns.

Those skilled in the art will appreciate that the routines illustrated in FIGS. 7-10 may be altered in a variety of ways. For example, the order of the blocks may be rearranged, substeps may be performed in parallel, shown blocks may be omitted, or other blocks may be included.

It will be appreciated by those skilled in the art that the above-described facility may be straightforwardly adapted or extended in various ways. For example, the facility may be used as a WINDOWS process for testing a POSIX process or subsystem. In addition, aspects of the facility may be combined with an integrated development environment that comprises a compiler, a linker, and test tools. While the foregoing description makes reference to particular embodiments, the scope of the invention is defined solely by the claims that follow and the elements recited therein.

We claim:

1. A method performed by a computer system for measuring code coverage of an executable object, comprising:
requesting an identification of basic blocks of the executable object;
adding a data structure to the executable object for storing code coverage information, the data structure comprising at least as many elements as there are basic blocks of the executable object; and
adding to each basic block of the executable object program instructions for updating an element of the data structure corresponding to the basic block.

2. The method of claim 1 including adding to the executable object program instructions for initializing the added data structure.

3. The method of claim 1 including adding to the executable object program instructions for updating a coverage file.

4. The method of claim 3 wherein the coverage file is updated when the executable object terminates.

5. The method of claim 3 wherein the coverage file is updated with contents of the data structure.

6. The method of claim 5 wherein the coverage file is updated with non-zero contents of the data structure.

7. The method of claim 1 wherein a basic block updates the element of the data structure corresponding to the basic block when the basic block is performed.

8. The method of claim 1 wherein the data structure is an array.

9. A computer-readable medium having computer-executable instructions for measuring code coverage of an executable object, the executable object adapted to include a data structure for storing code coverage data and program instructions for updating the code coverage data, the method comprising:
performing program instructions associated with a basic block of the executable object; and
updating the data structure for storing code coverage data with information indicating that the program instructions associated with the basic block of the executable object were executed.

10. The computer-readable medium of claim 9 wherein the updating is performed by the program instructions for updating the code coverage data.

11. The computer-readable medium of claim 9 wherein the updating includes setting a value associated with the element corresponding to the basic block of the executable object to a nonzero value.

12. The computer-readable medium of claim 9 including initializing the data structure before beginning to perform the executable object.

13. The computer-readable medium of claim 9 including storing each non-zero value of the data structure in a coverage file upon terminating the executable object.

14. The computer-readable medium of claim 9 wherein the data structure is an array having at least as many elements as exist basic blocks of the executable object.

15. A system for measuring code coverage of an executable object, comprising:
an object code tool component that receives an object code corresponding to the executable object to identify basic blocks, each basic block comprising a portion of source code corresponding to a portion of the object code; and
a test tool component that requests the object code tool to add to the executable object a data structure for storing code coverage information and program instructions for updating an element of the added data structure corresponding to a basic block.

16. The system of claim 15 wherein the test tool further adds to the executable object program instructions for initializing the data structure when the executable object starts to perform.

17. The system of claim 15 wherein the data structure is an array having at least as many elements as exist basic blocks of the executable object.

18. The system of claim 15 wherein the program instructions for updating an element of the added data structure corresponding to a basic block update the element when the basic block performs.

19. The system of claim 15 wherein the test tool component further adds to the executable object program instructions for storing values of the data structure to a coverage file when the executable object terminates.

20. The system of claim 19 wherein the test tool component retrieves values from the log file to identify source code line numbers corresponding to basic blocks that have not performed.
